(19) United States
(12) Patent Application Publication
(10) Pub. No.: US 2007/0123301 A1
(43) Pub. Date: May 31, 2007

(54) Handwriting input device for fax application

(76) Inventors: Yuan-Heng Wu, Taipei Hsien (TW); Chien-Feng Wang, Taipei Hsien (TW); Wei-Chao Wu, Taipei Hsien (TW)

Correspondence Address: YUAN-HENG WU, 235 Chung-Ho Box 8-24, Taipei, TW

(21) Appl. No.: 11/519,174

(22) Filed: Oct. 16, 2006

(30) Foreign Application Priority Data
Sep. 12, 2005 (TW) 094131377

(51) Int. Cl. H04M 1/00

(52) U.S. Cl. 455/556.1

(57) ABSTRACT

A handwriting input device for fax application connected to either the modem of a mobile phone or a built-in radio communication module having a function equivalent to a modem, whereby a user can send the content of a handwriting image to a remote fax machine by firstly writing a digital pen on a digital tablet, secondly transforming the recorded image into a fax format by a fax format transformation procedure, and eventually sending out the image by a mobile phone or a built-in radio communication module.

### FIELD OF THE INVENTION

The present invention relates to input devices for fax application, more particularly to handwriting input device for fax application, in which the technologies of digital tablets and mobile phones are integrated so that the handwriting of a user on a digital tablet can be transformed into a fax communication format and then transmitted to a remote fax machine by a mobile phone or an equivalent built-in radio communication module.

### BACKGROUND OF THE INVENTION

Following the swift development of information technologies, many of the documents in a company or produced by an individual are delivered by e-mails or through the Internet. On the other hand, traditional fax machines are not abandoned because the fax means is unique and has not been replaced yet. For example, the documents by handwriting and of high security (such as the copy of a contract) need to be delivered by fax machines.

Referring to FIG. 1, the fax means of the prior art comprises a sender's fax machine 11 and a receiver's fax machine 12. Before the content of a sheet of paper being delivered, the sheet of paper is firstly fed into an input terminal on the fax machine 11, and then a scanner therein transformed the content into fax format. Eventually, a modem in the fax machine 11 transmits the content to a telephone office 1 through a telephone line 10, and the content is then directed to the fax machine 12 indicated by a dialed telephone number. Finally, the received data are transformed back into the original image, thereby completing the fax process. However, the fax means of the prior art needs to be done in a place equipped with a fax machine, since the traditional fax machines are large due to the implantation of a scanner and a paper tray. Further, a conventional fax machine is linked with a telephone line and therefore restricted to places with a telephone line. Therefore, conventional fax machines are not as movable as notebook computers and mobile phones, largely restricting its flexibility.

Further, the conventional technology of digital writing pad includes a digital pen and a digital tablet capable of detecting the location where the pen touches the tablet and then transforming the location into coordinates. It is therefore a standard input device for a computer, which can replace a mouse for controlling the cursor on a computer screen. The digital tablet can detect the location of the digital pen and therefore allows the most natural input means, that is, handwriting.

On one hand, the use of a conventional fax machine is limited to occasions with a telephone line. On the other hand, a digital writing pad should be used with a computer. If the technologies of digital tablets and mobile phones are integrated, the handwriting of a user on a digital tablet can be transformed into a fax communication format and then transmitted to a remote fax machine by a mobile phone or an equivalent built-in radio communication module.

### SUMMARY OF THE INVENTION

The primary objective of the present invention is to provide a handwriting input device for fax application using either a transmission interface connected to the modem of a mobile phone or a built-in radio communication module with a modem to transmit data to another fax machine by dialing the phone number of the fax machine.

The secondary objective of the present invention is to provide a handwriting input device for fax application using a digital tablet, whereby a user can use the familiar handwriting means to input what is needed to fax. The digital tablet can detect the coordinates of a stroke on the tablet and form a data flow for storage. The stored data will be transformed into fax format for outward delivery.

It is a further objective that the present invention provides a handwriting input device for fax application wherein the modem in a conventional fax machine is replaced by the modem in a mobile phone or a built-in modem in a radio communication module. Therefore, the present invention is free from a telephone line and therefore limitation of occasions.

The various objects and advantages of the present invention will be more readily understood from the following detailed description when read in conjunction with the appended drawings.

### BRIEF DESCRIPTION OF THE DRAWINGS

FIG. 1 is a perspective view of a fax machine of the prior art.

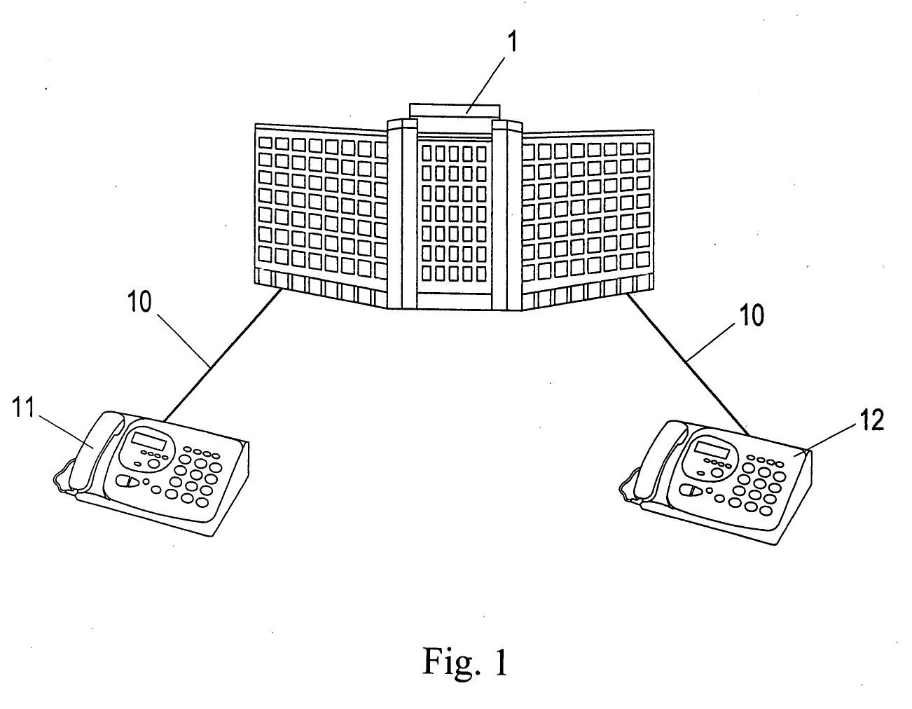

FIG. 2 is a system block diagram of a handwriting input device for fax application of the present invention.

FIG. 3 is a flow chart of the microprocessor control of the handwriting input device for fax application in FIG. 2.

FIG. 4 shows the operation of the first preferred embodiment of the present invention.

FIG. 5 is a system block diagram of the second preferred embodiment of the present invention.

FIG. 6 shows the operation of the second preferred embodiment of the present invention.

### DETAILED DESCRIPTION OF THE PREFERRED EMBODIMENTS

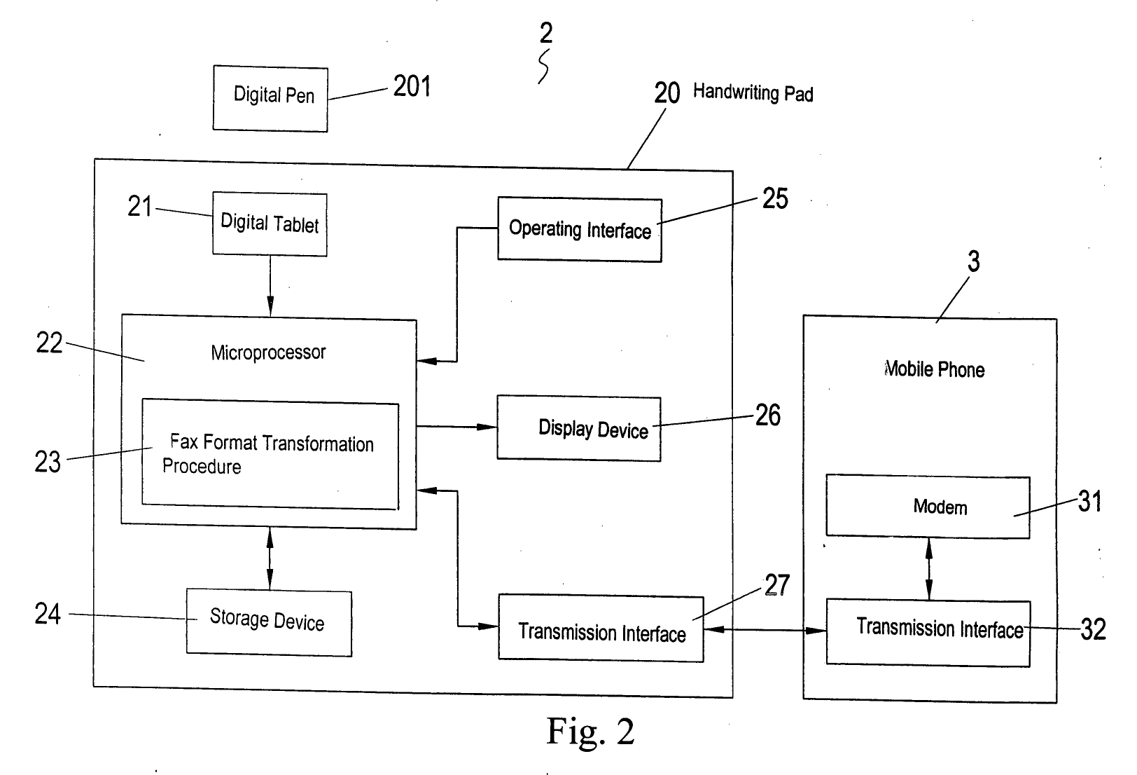

Referring to FIG. 2, a handwriting input device for fax application according to the present invention comprises a handwriting pad 20 and a digital pen 201.

The handwriting pad 20 mainly includes a digital tablet 21, a microprocessor 22 with a fax format transformation procedure 23, a storage device 24, an operating interface 25 and a display device 26 for displaying the status of handwriting pad which is selected from a light emitting diode (LED) panel and a liquid crystal display (LCD) panel. The handwriting pad 20 further comprises a transmission interface 27 connected to a mobile phone whose specification is selected from Bluetooth, infrared (IrDA) and any of the wireless transmission interfacing specifications utilized by mobile phones. The transmission interface 27 can also be either one of the wired transmission interfacing specifications utilized by mobile phones, such as USB or RS232.

The digital pen 201 contains a signal emission circuit and a power supply, whereby the digital pen 201 will emit signals when it is dragged on the digital tablet 21 of the handwriting pad 20. The digital pen 201 further includes an ink refill for leaving inked strokes on a sheet of paper placed on the handwriting pad 20.

Thereby, as the digital pen 201 is being dragged on the digital tablet 21, the digital tablet 21 will detect signals sent by the digital pen 201 and automatically transfers the signals into coordinates indicating the location of the digital pen 201. The information of the location is then received by the microprocessor 22 and stored in the storage device 24. The memory of the storage device 24 is built-in and may be selected from static random-access memory (SRAM), dynamic random-access memory (DRAM) and flash memory. However, the memory of the storage device 24 can also be an external memory card selected from Compact Flash Card, SD/MMC Memory Card and Memory Stick. Further, when a termination command of handwriting is input through the operating interface 25, the information of all coordinates saved in the storage device 24 will be transformed by the fax format transformation procedure 23. In the next step, the fax number to which the information will be transmitted is input on the operating interface 25 and sent. In this process, the microprocessor 22 will be communicating with the modem 31 in a mobile phone 3 through the transmission interface 27 of the handwriting pad 20, whereby the mobile phone 3 will transmit the fax-formatted data outwardly to another fax machine.

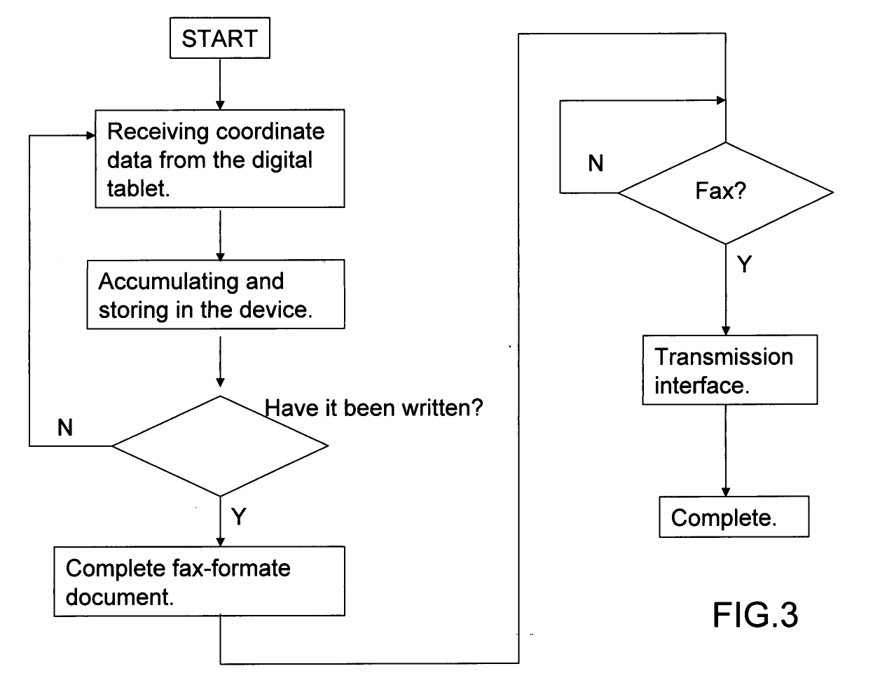

Referring to FIG. 3, the control process of the microprocessor starts at receiving the data concerning the coordinates on the handwriting pad and then saving them in the storage device. The process is then waiting a command indicating the end of the handwriting and will make a judgment. If the outcome is negative (N), the microprocessor continues to receive coordinate data. If the outcome is positive (Y), the data will be transformed into a fax-format. The process is directed to another judgment of fax. If the outcome is negative (N), the microprocessor continues to wait for a positive commend (Y). If the outcome is positive (Y), the data will be sent to the transmission interface for the completion of a fax action.

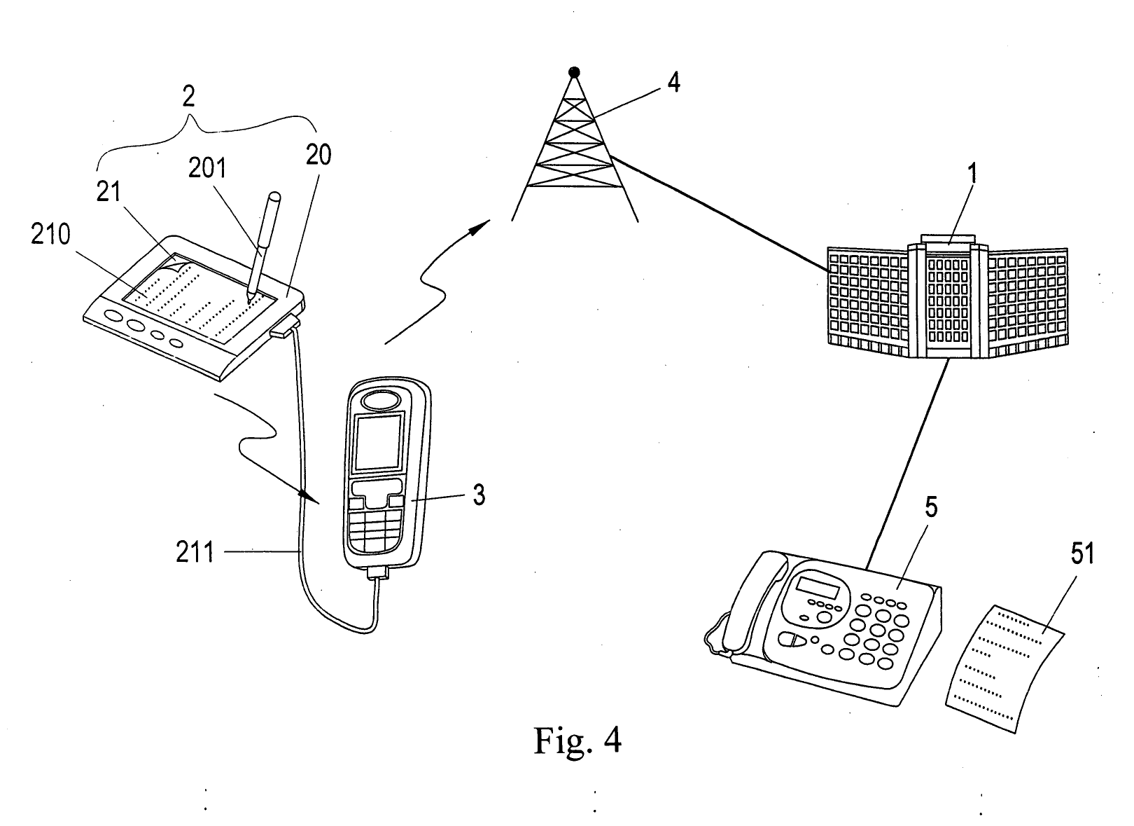

Referring to FIG. 4, the first preferred embodiment of the present invention as a handwriting input device for fax application 2 can be carried by a user. When the user wants to send a fax of his or her writing, the user places a sheet of paper 210 on the digital tablet 21 of the input device 2 and then draws at will on the paper 210. The handwriting on the paper 210 will be detected by the device 2, transformed into sequences of coordinate data and saved in the input device 2. When the writing is completed, a fax number and a fax recommend can be input on the handwriting pad 20. The handwriting pad 20 then uses a mobile phone 3 to connect a remote fax machine 5 and thereby transmits the data. The data will be firstly sent o a mobile-phone base station 4 and then to a telephone exchange office 1 by wired communication. The data will be redirected to the fax machine 5 by wired communication, and the fax machine 5 will generate a copy of the content of the paper 210 on another paper 51.

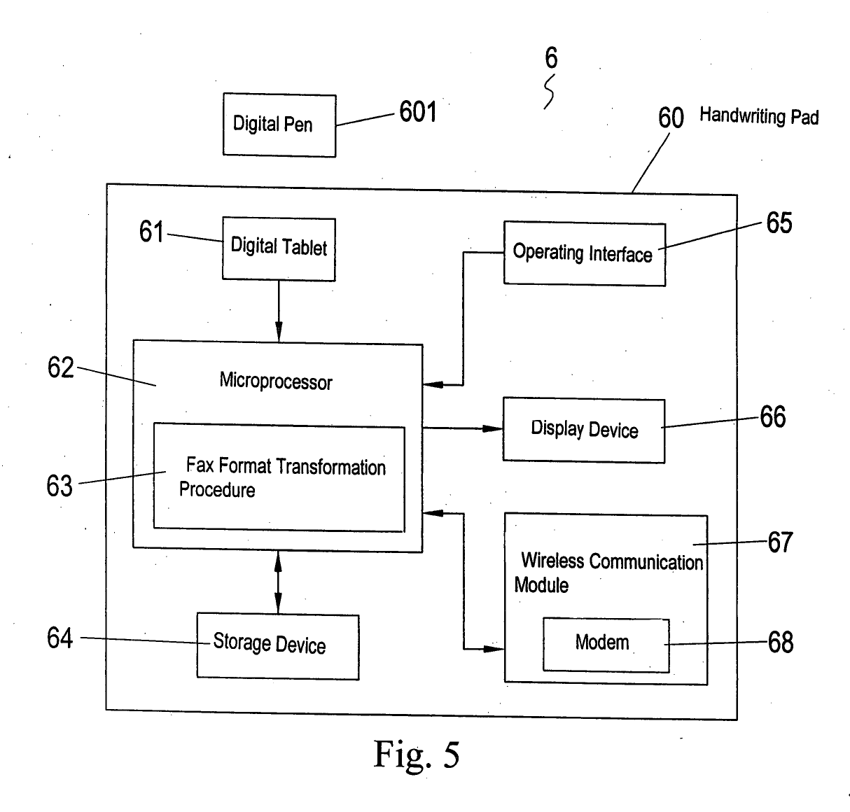

Referring to FIG. 5, the second preferred embodiment of the present invention as a handwriting input device for fax application 6 comprises a handwriting pad 60 and a digital pen 601.

The handwriting pad 60 mainly includes a digital tablet 61, a microprocessor 62 with a fax format transformation procedure 63, a storage device 64, an operating interface 65 and a display device 66 for displaying the status of handwriting pad which is selected from a light emitting diode (LED) panel and a liquid crystal display (LCD) panel. The handwriting pad 60 further comprises a radio communication module 67 with a modem 68; the specification of the radio communication module 67 is selected from GSM, GPRS, CDMA and WCDMA.

The digital pen 601 contains a signal emission circuit and a power supply, whereby the digital pen 601 will emit signals when it is dragged on the digital tablet 61 of the handwriting pad 60. The digital pen 601 further includes an ink refill for leaving inked strokes on a sheet of paper placed on the handwriting pad 60.

Thereby, as the digital pen 601 is being dragged on the digital tablet 61, the digital tablet 61 will detect signals sent by the digital pen 601 and automatically transfers the signals into coordinates indicating the stroke locations. The information of the locations is then received by the microprocessor 62 and stored in the storage device 64. The memory of the storage device 64 is built-in and may be selected from static random-access memory (SRAM), dynamic random-access memory (DRAM) and flash memory. However, the memory of the storage device 64 can also be an external memory card selected from Compact Flash Card, SD/MMC Memory Card and Memory Stick. Further, when a termination command of handwriting is input through the operating interface 65, the information of all coordinates saved in the storage device 64 will be transformed by the fax format transformation procedure 63. In the next step, the fax number to which the information will be transmitted is input on the operating interface 65. In this process, the microprocessor 62 will activate the modem 68 in the radio communication module 67 to hook up a communication with the fax machine associated with the input fax number, whereby the radio communication module 67 will transmit the fax-formatted data outwardly.

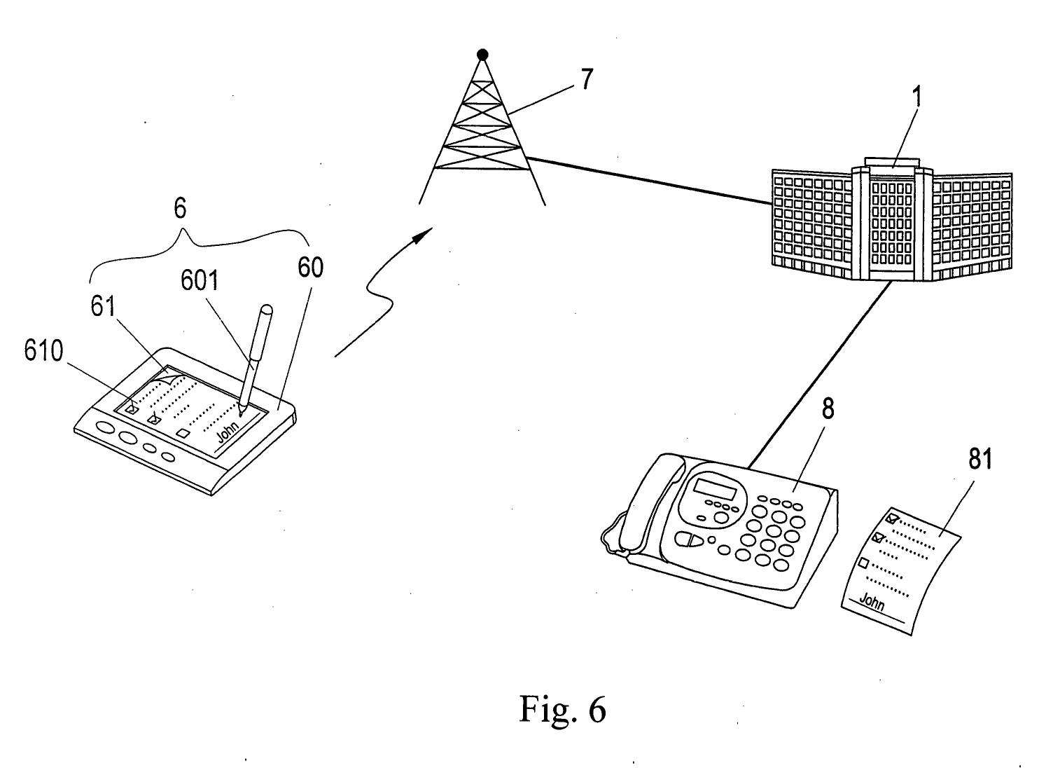

Referring to FIG. 6, the second preferred embodiment of the present invention as a handwriting input device for fax application 6 can be used by a user who wants to fax handwriting. A sheet of paper 610, which is a blank form, is placed on the digital tablet 61 of the input device 6. The fields of signature and for filling in will be ready for the user to sign or fill in. The format of the form is electronically saved in the storage device 64, whereby the content that the user had filled will be merged to form the final fax content. The fax therefore indicates a filled form. When the writing is completed, a fax number and a fax recommend can be input on the handwriting pad 60. The input device 6 then uses the radio communication module 67 to connect a remote fax machine 8 and thereby transmits the data. The data will be firstly sent to a mobile-phone base station 7 and then to a telephone exchange office 1 by wired communication. The data will; be redirected to the fax machine 8 by wired communication, and the fax machine 8 will generate a copy of the content of the filled form 610 on another paper 81.

To underscore the advantages of the present invention, it is compared with the conventional products.

1. The present invention utilizes a digital tablet as a fax input means by which a user can use a digital pen to write the content of the fax information, which is quite natural.

2. Since the fax data are locations of strokes recorded by the tablet, a scanner is not necessary.

3. The data of the stroke image can be sent out immediately or stored in the device for latter use; the original paper for handwriting needs not to be saved.

4. The digital data representing the fax content generated by the digital tablet can be saved in a linked computer for latter use; therefore, the procedure of scanning the original paper is not necessary.

5. The present invention uses the modem in a mobile phone as the dialing device, and therefore a telephone line is not necessary; the present invention is free from the limitation of operating occasions.

6. The writing and faxing can be done at any time effectively. For example, a contract signed can be faxed to the office after signature. The difficult of not finding a fax machine can be avoided.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A handwriting input device for fax application, comprising:
a handwriting pad further including at least a digital tablet, a microprocessor with a fax format transformation procedure, a storage device, an operating interface and a transmission interface connected to a mobile phone; and
a digital pen internally installed with at least a signal emission circuit;
whereby, as said digital pen touches said digital tablet, said digital tablet will detect signals sent by said digital pen, automatically transfer the signals into coordinate information of handwriting, said microprocessor receives the coordinate information sent by said digital tablet and store coordinate information into said storage device, whereby said microprocessor will transform said coordinate data into a standard fax format by said fax format transformation procedure therein and build up connection with a modem in a mobile phone via said transmission interface of said handwriting pad, and whereby said mobile phone will transmit said information outwardly to another fax machine.

2. A handwriting input device for fax application, comprising:
a handwriting pad further including at least a digital tablet, a microprocessor with a fax format transformation procedure, a storage device, an operating interface and a radio communication module with a modem; and
a digital pen internally installed with at least a signal emission circuit;
whereby, as said digital pen touches said digital tablet, said digital tablet will detect signals sent by said digital pen, automatically transfer the signals into coordinate information of handwriting, said microprocessor receives the coordinate information sent by said digital tablet and store coordinate information into said storage
microprocessor receives the coordinate information sent by said digital tablet and store coordinate information into said storage device, whereby said microprocessor will transform said coordinate data into a standard fax format by said fax format transformation procedure therein and activate said modem in said radio communication module for dialing another fax machine, and whereby said radio communication module will transmit said information outwardly.

3. The handwriting input device for fax application of claim 1 wherein said digital pen further includes an ink refill for leaving inked strokes on a sheet of paper placed on said handwriting pad.

4. The handwriting input device for fax application of claim 2 wherein said digital pen further includes an ink refill for leaving inked strokes on a sheet of paper placed on said handwriting pad.

5. The handwriting input device for fax application of claim 1 wherein paper sheets of various sizes can be placed on said digital tablet of said handwriting pad, and handwriting on any of said paper sheets will be registered and duplicated in another fax machine.

6. The handwriting input device for fax application of claim 2 wherein paper sheets of various sizes can be placed on said digital tablet of said handwriting pad, and handwriting on any of said paper sheets will be registered and duplicated in another fax machine.

7. The handwriting input device for fax application of claim 1 wherein a sheet of paper placed on said digital tablet is a blank form whose format is electronically saved firstly in said storage device, whereby filled fields by a user will be merged to form a final fax content.

8. The handwriting input device for fax application of claim 2 wherein a sheet of paper placed on said digital tablet is a blank form whose format is electronically saved firstly in said storage device, whereby filled fields by a user will be merged to form a final fax content.

9. The handwriting input device for fax application of claim 1 wherein said storage device is selected from static random-access memory (SRAM), dynamic random-access memory (DRAM) and flash memory.

10. The handwriting input device for fax application of claim 2 wherein said storage device is selected from static random-access memory (SRAM), dynamic random-access memory (DRAM) and flash memory.

11. The handwriting input device for fax application of claim 1 wherein said storage device is an external memory card selected from Compact Flash Card, SD/MMC Memory Card and Memory Stick.

12. The handwriting input device for fax application of claim 2 wherein said storage device is an external memory card selected from Compact Flash Card, SD/MMC Memory Card and Memory Stick.

13. The handwriting input device for fax application of claim 1 wherein said handwriting pad is installed with at least a display panel selected from a light emitting diode (LED) panel and a liquid crystal display (LCD) panel for displaying the status of the handwriting pad.

14. The handwriting input device for fax application of claim 2 wherein said handwriting pad is installed with at least a display panel selected from a light emitting diode (LED) panel and a liquid crystal display (LCD) panel for displaying the status of the handwriting pad.

15. The handwriting input device for fax application of claim 1 wherein said transmission interface connected to a mobile phone whose specification is selected from Bluetooth, infrared (IrDA) and any of wireless transmission interfacing specifications utilized by mobile phones.

16. The handwriting input device for fax application of claim 1 wherein said transmission interface is selected from USB, RS232 and either one of wired transmission interfacing specifications utilized by mobile phones.

17. The handwriting input device for fax application of claim 2 wherein the specification of said radio communication module is selected from GSM, GPRS, CDMA and WCDMA.
